(19) United States
(12) Patent Application Publication
(10) Pub. No.: US 2022/0229583 A1
(43) Pub. Date: Jul. 21, 2022

(54) AI ALGORITHM OPERATION ACCELERATOR AND METHOD THEREOF, COMPUTING SYSTEM AND NON-TRANSITORY COMPUTER READABLE MEDIA

(71) Applicant: Genesys Logic, Inc., New Taipei City (TW)

(72) Inventors: Wen-Hsiang LIN, New Taipei City (TW); Shih-Yao CHENG, New Taipei City (TW); Jin-Min LIN, New Taipei City (TW)

(21) Appl. No.: 17/578,307

(22) Filed: Jan. 18, 2022

Related U.S. Application Data
(60) Provisional application No. 63/139,809, filed on Jan. 21, 2021.

(30) Foreign Application Priority Data
Nov. 8, 2021 (TW) 110141505

(51) Int. Cl. G06F 3/06

(52) U.S. Cl. CPC G06F 3/0655; G06F 3/0673; G06F 3/0604

(57) ABSTRACT

The application provides an AI algorithm operation accelerator and method, a computing system, and a non-transitory computer readable media. The AI algorithm operation accelerating method includes steps of: A. reading an input data and a descriptor from a memory unit, wherein the descriptor includes a weight data; B. performing a first part of the input data and a first part of the weight data by a first operator for generating a first operation result; C. registering the first operation result; D. when the first operation result reaches a predetermined data amount, triggering a second operator to perform the first operation result and a second part of the weight data by the second operator for generating a second operation result; and E. writing the second operation result into the memory unit.

This application claims the benefit of U.S. provisional application Ser. No. 63/139,809, filed Jan. 21, 2021, and Taiwan application Serial No. 110141505, filed Nov. 8, 2021, the subject matters of which are incorporated herein by references.

### TECHNICAL FIELD

The disclosure relates in general to an AI (artificial intelligence) algorithm operation accelerator and a method thereof, a computing system and a non-transitory computer readable media.

### BACKGROUND

Edge computing is a network operation structure which reduces latency and bandwidth usage by closing data source during operation. The purpose of edge computing is to reduce operation amounts executed on the central remote location (for example, a cloud server), and thus to reduce communication between local users and servers as much as possible. Recently, edge computing become more practical because rapid technology development.

In the field of edge computing, user client devices (for example but not limited by, smart phones) not only accelerate data processing and transmission rate, but also shorten latency. Edge computing may be also implemented by AI hardware accelerators of user client devices.

Recently, Artificial Neural Network (ANN) has huge development from Perceptron, AlexNet to VGG (Visual Geometry Group). Accuracy of ANN is improving but AI models are more and more complicated. Complicated AI models raise a problem of huge operation amount and thus, it is impractical to operate complicated AI models on low-level product (for example, smart phones). “MobileNet” is developed to solve the prior art problem by improving processing speed.

In MobileNet algorithm, it is important to simplify the prior convolution operations by dividing convolution operations into depthwise convolution operations and pointwise convolution operations.

MobileNet V1 has good accuracy and improves processing speed. In MobileNet V1 algorithm, depthwise convolution operations are used to replace prior standard convolution for reducing operation amounts. Now, MobileNet V1 is improved into MobileNet V2.

Compared with MobileNet V1, MobileNet V2 has two main changes: linear bottleneck and inverted residual blocks.

Linear Bottleneck discards nonlinear activation layer after small-dimension output layer in order to ensure model expression ability.

As for residual blocks, dimensions are reduced first and then increased; and on the contrary, as for inverted residual blocks, the dimensions are increased first and then reduced. Advantages of inverted residual blocks rely on reusing repeated features to ease feature degeneration.

Many kinds of high efficient convolution operations are developed to improve prior convolution operations. However, in prior convolution operations, input data is read from the memory unit, the operator performs a single operation on the input data and the operation result is written back to the memory unit. Data read, data operations and data storage are repeated based on the algorithm. Data read and data write from/into the memory unit involve power consumption. Thus, how to have maximum operation on single data read and data storage is a big issue in high efficient convolution operations. Also, another importance of improving high efficient convolution operations is to divide the prior convolution operations into several stages, but the operation amounts in different stages are different, which causes poor utility rate of the same operator in different stages.

Thus, it is one of the efforts to develop a high efficient and low power consumption AI algorithm operation accelerator, a method thereof, a computing system and a non-transitory computer readable media.

### SUMMARY

According to one embodiment, an AI algorithm operation accelerator to perform operations on an input data in a memory unit is provided. The memory unit includes a first data storage region for storing the input data, a second data storage region for storing a descriptor which includes a weight data, and a third data storage region for storing an output data. The AI algorithm operation accelerator includes: a first register region for registering a part of the input data, wherein the first register region is configured a predetermined data length; a second register region for registering a first part of the descriptor; a third register region for registering a first part of the weight data; a first operator for operating the first part of the input data and the first part of the weight data to generate a first operation result; a fourth register region for registering the first operation result; a fifth register region for registering a second part of the weight data; and a second operator for operating the first operation result and the second part of the weight data to generate a second operation result, wherein when a predetermined data amount is stored in the fourth register region, the second operator is triggered to operate the first operation result and the second part of the weight data.

According to another embodiment, an AI algorithm operation accelerating method is provided. The AI algorithm operation accelerating method includes steps of: A. reading an input data and a descriptor from a memory unit, wherein the descriptor includes a weight data; B. performing a first part of the input data and a first part of the weight data by a first operator for generating a first operation result; C. registering the first operation result; D. when the first operation result reaches a predetermined data amount, triggering a second operator to perform the first operation result and a second part of the weight data by the second operator for generating a second operation result; and E. writing the second operation result into the memory unit.

According to another embodiment, a computing system is provided. The computing system includes: a memory unit including a first data storage region for storing an input data, a second data storage region for storing a descriptor which includes a weight data, and a third data storage region for storing an output data; a memory read-write controller coupled to the memory unit, for controlling read and write of the memory unit; and an AI algorithm operation accelerator coupled to the memory read-write controller, the AI algorithm operation accelerator including: a first register region for registering a part of the input data, wherein the first register region is configured a predetermined data length; a second register region for registering a first part of the descriptor; a third register region for registering a first part of the weight data; a first operator for operating the first part of the input data and the first part of the weight data to generate a first operation result; a fourth register region for registering the first operation result; a fifth register region for registering a second part of the weight data; and a second operator for operating the first operation result and the second part of the weight data to generate a second operation result, wherein when a predetermined data amount is stored in the fourth register region, the second operator is triggered to operate the first operation result and the second part of the weight data.

According to another embodiment, a non-transitory computer readable media storing a program code readable and executable by a computer is provided. When the program code is executed by the computer, the computer performs steps of: A. reading an input data and a descriptor from a memory unit, wherein the descriptor includes a weight data; B. performing a first part of the input data and a first part of the weight data by a first operator for generating a first operation result; C. registering the first operation result; D. when the first operation result reaches a predetermined data amount, triggering a second operator to perform the first operation result and a second part of the weight data by the second operator for generating a second operation result; and E. writing the second operation result into the memory unit.

### BRIEF DESCRIPTION OF THE DRAWINGS

FIG. 1 shows a functional diagram of a computing system 100 according to one embodiment of the application.

FIG. 2 shows an AI algorithm operation accelerating method according to one embodiment of the application.

FIG. 3A and FIG. 3B show an AI algorithm operation accelerating method according to another embodiment of the application.

FIG. 4A shows the first operator according to one embodiment of the application.

FIG. 4B shows the second operator according to one embodiment of the application.

FIG. 5 shows data flow of writing data into the fourth register region.

FIG. 6 shows the input data stored in the input data storage region of the memory unit.

FIG. 7A shows the first part of the weight data according to one embodiment of the application.

FIG. 7B shows the second part of the weight data according to one embodiment of the application.

FIG. 8A to FIG. 8H show operations of the AI algorithm operation accelerator 120 according to one embodiment of the application.

FIG. 9 shows the output data when the movement parameter Stride₁ₛₜ of the first layer convolution operation is 1 and 2, respectively, in one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

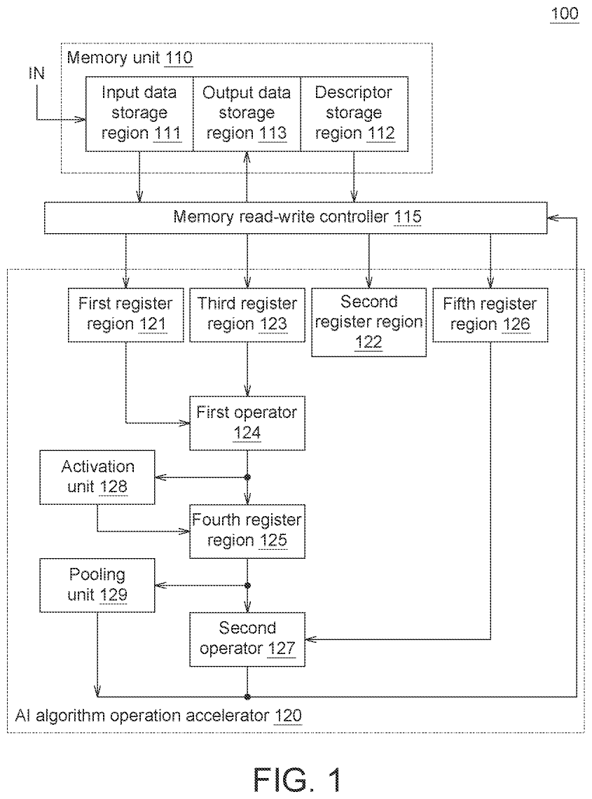

FIG. 1 shows a functional diagram of a computing system 100 according to one embodiment of the application. The computing system 100 includes a memory unit 110, a memory read-write controller 115 and an AI algorithm operation accelerator 120. The memory read-write controller 115 is coupled to the memory unit 110 and the AI algorithm operation accelerator 120.

The AI algorithm operation accelerator 120 is suitable to perform operations on an input data in the memory unit 110 (for example but not limited by a dynamic random access memory (DRAM)).

The memory unit 110 includes an input data storage region 111 for storing an input data IN; a descriptor storage region 112 for storing a descriptor which includes a weight data; and an output data storage region 113 for storing an output data.

The memory read-write controller 115 reads data (for example the input data IN and the descriptor) from the memory unit 110 into the AI algorithm operation accelerator 120 and thus the AI algorithm operation accelerator 120 performs MAC (Multiply Accumulate, MAC) operations. The memory read-write controller 115 further writes the MAC operation results from the AI algorithm operation accelerator 120 into the memory unit 110.

The AI algorithm operation accelerator 120 includes: a first register region 121 (for example but not limited by, a static random access memory, SRAM) for registering a part of the input data, wherein the first register region 121 is configured a predetermined data length; a second register region 122 (for example but not limited by SRAM) for registering a part of the descriptor; a third register region 123 (for example but not limited by SRAM) for registering a first part of the weight data; a first operator 124 (for example a MAC operator) for operating the input data and the first part of the weight data to generate a first operation result, wherein the first operator has a first maximum operation capacity; a fourth register region 125 (for example but not limited by SRAM) for registering the first operation result, wherein the fourth register region 125 is configured at least triple times (or more) of the predetermined data length; a fifth register region 126 (for example but not limited by SRAM) for registering a second part of the weight data; and a second operator 127 (for example a MAC operator) for operating the first operation result and the second part of the weight data to generate a second operation result, wherein the second operator has a second maximum operation capacity smaller than the first maximum operation capacity. When a predetermined data amount is stored in the fourth register region 125, the second operator 127 is triggered to operate the first operation result and the second part of the weight data. When the second operator 127 is in operation, the first operator 124 continues in operating the input data. Setting of the predetermined data amount is based on the descriptor. Further, setting of the predetermined data amount which triggers the second operator is determined based on a batch width and a filter parameter.

In one possible embodiment of the application, the AI algorithm operation accelerator 120 further optionally includes an activation unit 128 for performing activation operation on the first operation result from the first operator 124. Operations performed by the activation unit 128 include, for example but not limited by, rectified linear unit (ReLU) operations, sigmoid operations, Tanh operations and so on. In one embodiment of the application, the activation operation is optional and is set in the descriptor.

In one possible embodiment of the application, the AI algorithm operation accelerator 120 further optionally includes a pooling unit 129 for performing pooling operations on the first operation result from the fourth register region 125. Operations performed by the pooling unit 129 include, for example but not limited by, Max-Pooling operations, Mean-Pooling operations, Stochastic-Pooling operations and so on. The pooling operation results from the pooling unit 129 are input into the memory read-write controller 115. In one embodiment of the application, the pooling operations and the second operations are at the same level; and one between the pooling operations and the second operations is selected, and the selection is set in the descriptor.

In one possible embodiment of the application, the first operator 124 further includes a first operation element array having a plurality of first operation elements. Each of the first operation elements is configured to: receive the input data and the first part of the weight data corresponding to multi-dimensional positions; and process the input data and the first part of the weight data to generate a plurality of operation results as the first operation result. In one embodiment of the application, “multi-dimensional positions” refers to different data points, for example but not limited by, data on the coordinates of two-dimension plane coordinate system.

In one possible embodiment of the application, the second operator 127 further includes a second operation element array having a plurality of second operation elements. Each of the second operation elements is configured to: receive the first operation result and the second part of the weight data corresponding to multi-dimensional positions; and process the first operation result and the second part of the weight data to generate a plurality of operation results as the second operation result. The second operation result generated by the second operator 127 is written into the memory unit 110 via the memory read-write controller 115. The number of the first operation elements is larger than the number of the second operation elements. During the second operator 127 operates, the first operator 144 and the second operator 127 are in parallel processing state which refers that the first operator 144 and the second operator 127 may perform respective operation processing concurrently.

In one embodiment of the application, the descriptor includes, for example but not limited by, layer number, filter setting, pooling setting, input feature map size, channel number, the start address of the input feature map, the start address of the output feature map, sub-layer descriptor pointer, the activation setting, and so on.

In one embodiment of the application, the first register region 121 is for example but not limited by, a first-in-first-out (FIFO) register region for sending the input data to the first operator 124 in FIFO.

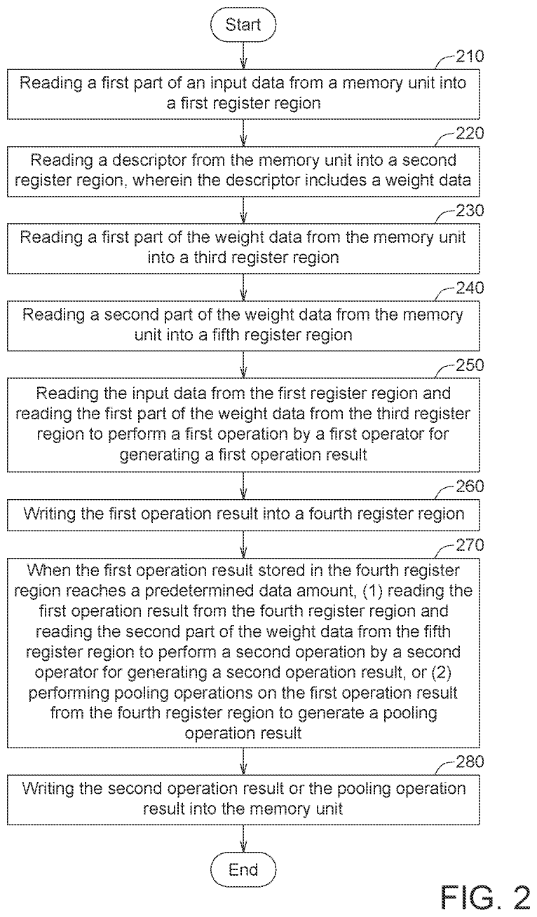

FIG. 2 shows an AI algorithm operation accelerating method according to one embodiment of the application. The method includes: reading a first part of an input data from a memory unit into a first register region (210); reading a descriptor from the memory unit into a second register region, wherein the descriptor includes a weight data (220); reading a first part of the weight data from the memory unit into a third register region (230); reading a second part of the weight data from the memory unit into a fifth register region (240); reading the input data from the first register region and reading the first part of the weight data from the third register region to perform a first operation by a first operator for generating a first operation result (250); writing the first operation result into a fourth register region (260); when the first operation result stored in the fourth register region reaches a predetermined data amount, (1) reading the first operation result from the fourth register region and reading the second part of the weight data from the fifth register region to perform a second operation by a second operator for generating a second operation result, or (2) performing pooling operations on the first operation result from the fourth register region to generate a pooling operation result (270); and writing the second operation result or the pooling operation result into the memory unit (280).

In one embodiment of the application, an activation operation is optionally included between the steps 250 and 260.

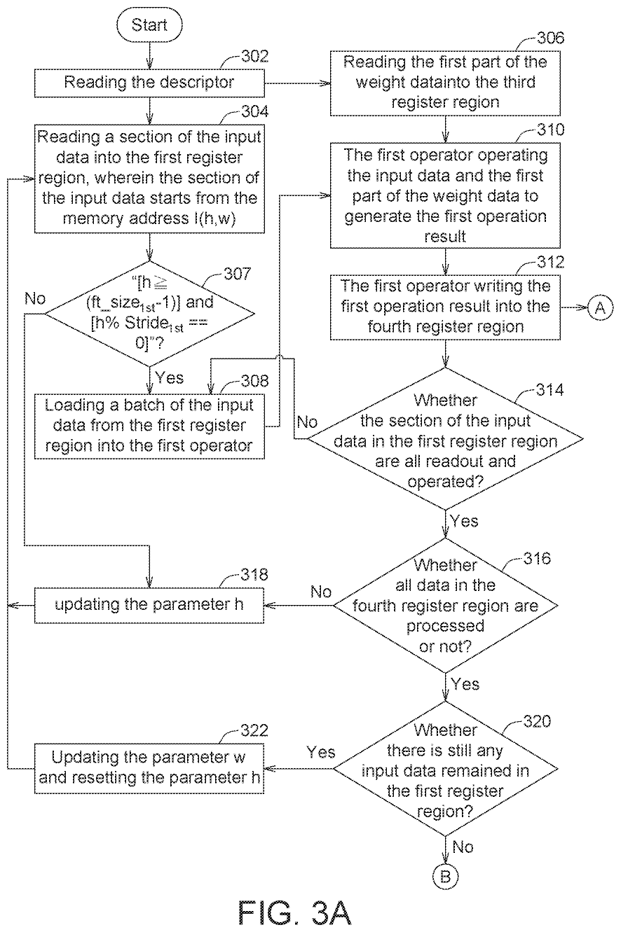

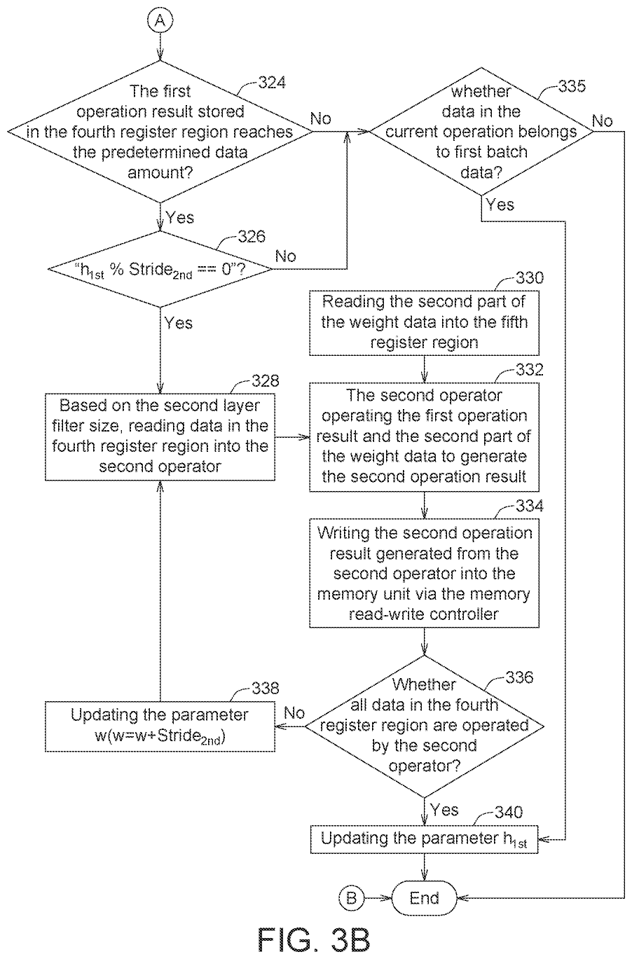

FIG. 3A and FIG. 3B show an AI algorithm operation accelerating method according to another embodiment of the application.

In the step 302, the AI algorithm operation accelerator 120 reads the descriptor from the descriptor register region 112 of the memory unit 110. In details, when the input data and the descriptor are written into the memory unit 110, a notice is issued to the AI algorithm operation accelerator 120, and thus the AI algorithm operation accelerator 120 reads the input data and the descriptor. By so, the AI algorithm operation accelerator 120 is triggered to perform operations.

In the step 304, the AI algorithm operation accelerator 120 reads a section of the input data from the input data storage region 111 of the memory unit 110 into the first register region 121, wherein the section of the input data starts from the memory address I(h,w) (h and w are both positive integers) and the width of the readout data is the section width sect_width.

In the step 306, the AI algorithm operation accelerator 120 reads the first part of the weight data from the descriptor storage region 112 of the memory unit 110 into the third register region 123.

In the step 307, it is determined whether “h≥(ft_size₁ₛₜ−1) and (h % Stride₁ₛₜ==0)” are both satisfied, wherein “h % Stride₁ₛₜ==0” refers to whether the data address h is divisible by the parameter “Stride₁ₛₜ”, the parameter “ft_size₁ₛₜ” refers to the filter size of the first convolution operation, the parameter “Stride₁ₛₜ” refers to the movement amount of the first convolution operation. In the convolution operation, the operation target is operated by gradual address movement based on the filter (or said the kernel). The parameter “Stride” is the movement set of the filter. When the parameter “Stride” is set as “1”, the operation is executed once in each address forward movement; and when the parameter “Stride” is set as “2”, the operation is executed once in twice address forward movement. So, when the parameter “Stride” is set above “2”, the operation amount is reduced. In one embodiment of the application, the step 307 is optional. When the step 307 is yes, the flow proceeds to the step 308; and when the step 307 is no, the flow proceeds to the step 318. For example, when the filter size of the first convolution operation is “1”, after the input data at “h=0” is read, the step 308 is performed. When the filter size of the first convolution operation is “3”, after the input data at “h=0, h=1 and h=2” are all read, the step 308 is performed.

In the step 308, the AI algorithm operation accelerator 120 loads a batch of the input data from the first register region 121 into the first operator 124, wherein the data width of the batch is the batch width WB (WB being a positive integer) and the batch width is smaller than the section width.

In the step 310, the first operator 124 of the AI algorithm operation accelerator 120 operates the input data and the first part of the weight data to generate the first operation result.

In the step 312, the first operator 124 of the AI algorithm operation accelerator 120 writes the first operation result into the fourth register region 125. For example but not limited by, the fourth register region 125 is configured at least “m” times of the predetermined data length (for example but not limited by, m=3) and the fourth register region 125 is rewritable, wherein the predetermined data length is equal to the section width.

In the step 314, it is determined whether the section of the input data in the first register region 121 are all readout and operated. When the step 314 is not, the flow returns to the step 308 and the AI algorithm operation accelerator 120 loads the next batch (having data width of WB) of the input data from the first register region 121 into the first operator 124. When the step 314 is yes, then the flow proceeds to the step 316.

In the step 316, it is determined whether all data in the fourth register region 125 are processed or not, for example but not limited by, determining whether h is equal to hₘₐₓ, hₘₐₓ referring to the maximum value of the data address h of the input data. When the step 316 is no, then the flow proceeds to the step 318; and when the step 316 is yes, then the flow proceeds to the step 320.

In the step 318, the parameter h is updated. For example, the parameter h is updated as h=h+1 to read the next data.

In the step 320, it is determined whether there is still any input data remained in the first register region 121. When the step 320 is not (that is, all the input data in the first register region 121 are read out), then the operation flow is completed. When the step 320 is yes (that is there is still any input data remained in the first register region 121), then the flow proceeds to the step 322.

In the step 322, the parameter w is updated and the parameter h is reset. For example but not limited by, the parameter w is updated as w=w+sect_width−(ft_size₁ₛₜ−1+ft_size_{2nd}−1) and the parameter h is reset as h=0, wherein the parameter “ft_size_{2nd}” is the filter size of the second layer convolution operation. After the step 322 is performed, the flow returns to the step 304. In one embodiment of the application, in case that “sect_width” is 32, then in the initial operation, a section of the input data is read out from the input data storage region 111 of the memory unit 110 to read the first data (having address of 0) to the thirty-second data (having address of 31) of the input data; in the subsequent operation, based on the filter size of the operation, the start address of the next read data is determined, wherein the filter size is set in the descriptor. For example but not limited by, the first layer filter size (ft_size₁ₛₜ) is 1*1 while the second layer filter size (ft_size_{2nd}) is 3*3. Because the first data operation of the second layer is calculated by using the thirty-first data (having address 30) to the thirty-third data (having address 32), a section of the input data is read out from the input data storage region 111 of the memory unit 110 to read the thirty-first data (having address of 30) to the sixty-second data (having address of 61) of the input data for calculation.

Further, after the step 312 is performed, the step 324 is performed.

In the step 324, it is determined whether the first operation result stored in the fourth register region 125 reaches the predetermined data amount. When the step 324 is yes, the flow proceeds to the step 326; and when the step 324 is no, the flow proceeds to the step 335.

In the step 326, it is determined whether “h₁ₛₜ % Stride_{2nd}==0”. When the step 326 is yes, the flow proceeds to the step 328; and when the step 326 is no, the flow proceeds to the step 335. The step 326 is also an optional step, which is similar to the step 307. “h₁ₛₜ % Stride_{2nd}==0” refers to that whether the parameter hi st is divisible by the parameter stride_{2nd}, the parameter stride_{2nd} refers the movement amount of the second convolution layer and h₁ₛₜ refers to the data address h of the first operation result stored in the fourth register region 125.

In the step 328, based on the second layer filter size, data in the fourth register region 125 is read into the second operator 127. For example but not limited by, when the second layer filter size is 3*3, data at the addresses “p([0 . . . 2], [w . . . w+2])” in the fourth register region 125 are read into the second operator 127. In another embodiment, when the second layer filter size is 5*5, data at the addresses “p([0 . . . 4], [w . . . w+4])” in the fourth register region 125 are read into the second operator 127.

Further, in the step 330, the AI algorithm operation accelerator 120 reads the second part of the weight data from the descriptor storage region 112 of the memory unit 110 into the fifth register region 126. In one embodiment of the application, the steps 330, 304 and 306 are completed at the same.

In the step 332, the second operator 127 of the AI algorithm operation accelerator 120 operates the first operation result (i.e. data readout from the fourth register region 125 at the step 328) and the second part of the weight data (stored in into the fifth register region 126 at the step 330) to generate the second operation result.

In the step 334, the second operation result generated from the second operator 127 is written into the memory unit 110 via the memory read-write controller 115.

In the step 335, it is determined whether data in the current operation belongs to first batch data. For example, it is determined whether the parameter w is smaller or equal to the batch width. When the step 335 is yes, the flow proceeds to the step 340; and when the step 335 is no, the flow ends.

In the step 336, it is determined whether all data in the fourth register region 125 are operated by the second operator 127. For example, it is determined whether the parameter w is equal to wₘₐₓ referring to the maximum data address w of the first operation result. In one example, wₘₐₓ is equal to the section width. When the step 336 is yes, the flow proceeds to the step 340; and when the step 336 is no, the flow proceeds to the step 338.

In the step 338, the parameter w is updated (w=w+Stride_{2nd}) and the flow returns to the step 328.

In the step 340, the parameter h₁ₛₜ is updated (h₁ₛₜ=h₁ₛₜ+1). The flow ends.

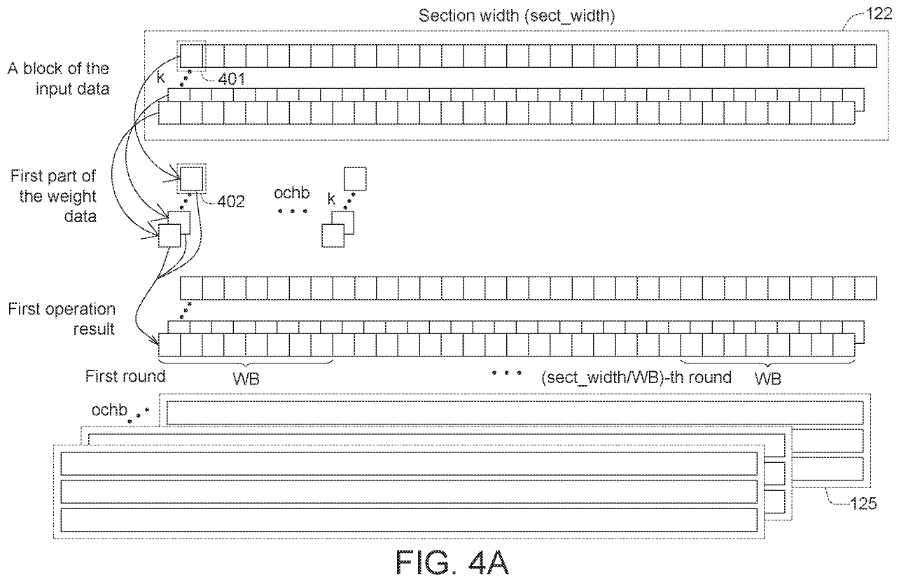

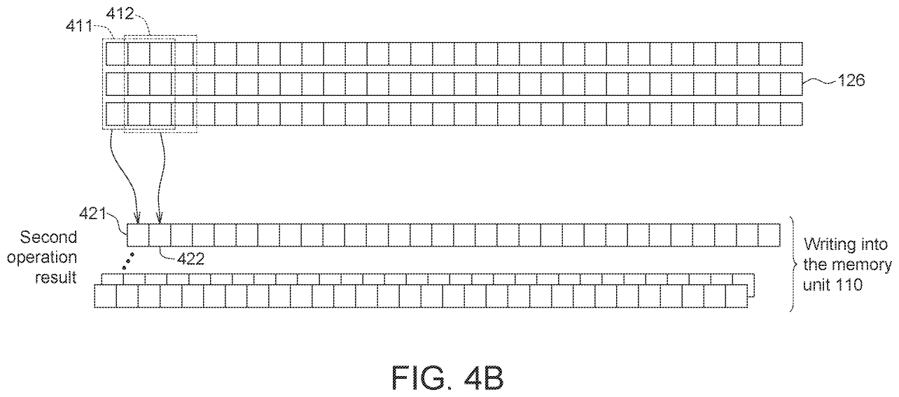

FIG. 4A shows the first operator according to one embodiment of the application. In FIG. 4A, the parameter “ochb” refers to the number of the output channel batch and the parameter “k” refers to the number of the input channel. In one embodiment, the first layer operation (i.e. the first operation) uses the pointwise convolution algorithm structure to operate the input data to convert the channel number by using 1*1 filter size, wherein the operation amount of the first layer operation is expressed as “1*1*k*ochb”. As shown in FIG. 4A, the respective input data (marked by the dotted block 401) and the first part of the respective weight data (the first part of the respective weight data being marked by the dotted block 402) are multiplied and accumulated to generate the first operation result. The first operation result of each round is written into the fourth register region 125.

FIG. 4B shows the second operator according to one embodiment of the application. As shown in FIG. 4B, when there are nine (=3*3=9) data 411 written into the fourth register region 125, the second operator 127 operates on the second layer input data (i.e. the nine data 411 stored in the fourth register region 125) and the second part of the weight data (stored in the fifth register region 126) to generate the second operation result 421. The second operation result 421 is written into the output data storage region 113 of the memory unit 110. When nine (=3*3=9) data 412 are written into the fourth register region 125, the second operator 127 operates on the second layer input data (i.e. the nine data 412 stored in the fourth register region 125) and another second part of the weight data to generate another second operation result 422. The second operation result 422 is written into the output data storage region 113 of the memory unit 110.

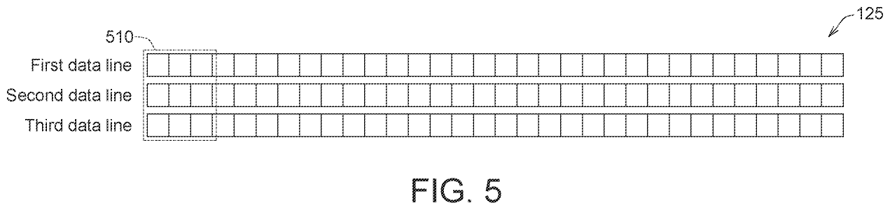

FIG. 5 shows data flow of writing data into the fourth register region 125. In the first round, the first operator 124 writes the first operation result (having bit of WB (for example but not limited by, 8 bits)) into the first data line of the fourth register region 125. In the subsequent rounds, the first operator 124 writes the subsequent first operation results into the first data line of the fourth register region 125. When the first data line is full, the first operation result is written into the second data line; and when the second data line is full, the first operation result is written into the third data line. Each length of the data line is for example but not limited by, the section width of the input data of the memory unit 110.

Further, the predetermined data amount is determined based on the second layer filter size. For example, when the second layer filter size is 3*3, the predetermined data amount is total bits of nine data in the data lines. As shown in FIG. 5, when the first two data lines are full and the first three data on the third data line is stored, as shown by the dotted block 510, the second operation is triggered. That is, the second operator 127 operates on the second layer input data (nine data of the dotted block 510 in the fourth register region 125) and the second part of the weight data to generate the second operation result.

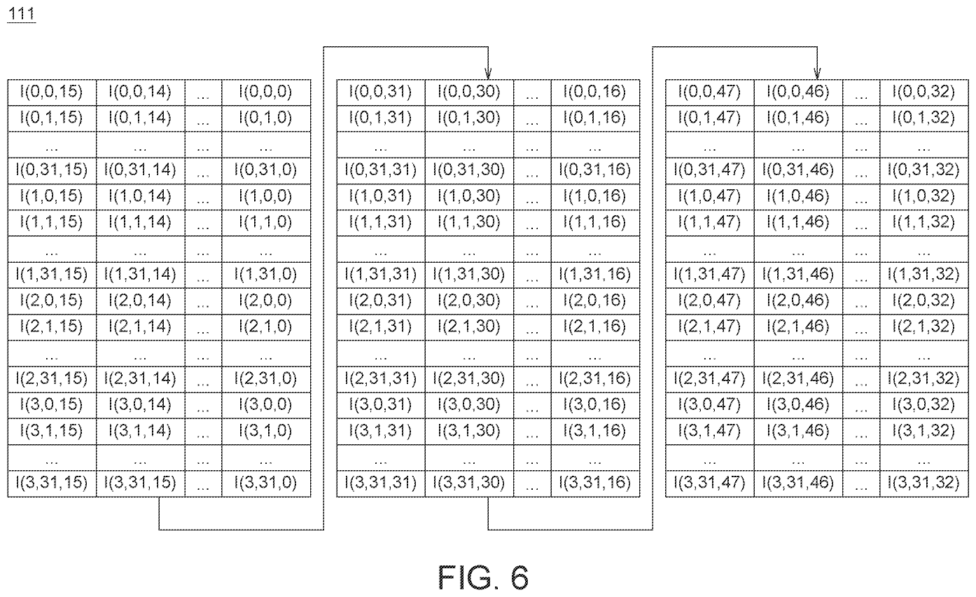

FIG. 6 shows the input data stored in the input data storage region 111 of the memory unit 110. In one example, for example but not limited by, the input data may be the input feature map having size of h*w*k (for example, 4*32*48) and the input data are stored at the addresses I(0,0,0)˜I(3,31,47).

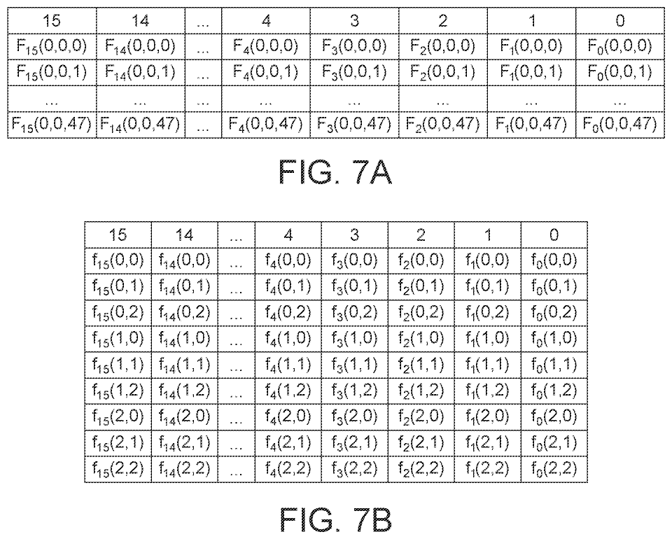

FIG. 7A shows the first part of the weight data according to one embodiment of the application. In one embodiment, in the case that the filter size is 1*1, the weight data is data amount of 1*1*k*n, wherein “k” refers to the channel number of the input data, “n” refers to the channel number of the output data. In FIG. 7A, k=48, n=16. FIG. 7B shows the second part of the weight data according to one embodiment of the application. In one embodiment, in the case that the filter size is 3*3, the weight data is data amount of 3*3*n. In FIG. 7B, n=16. In FIG. 7A, F₀(0,0,0)˜F₁₅(0,0,47) indicate the first part of the weight data. In FIG. 7B, f₀(0,0)˜f₁₅(2,2) indicate the second part of the weight data.

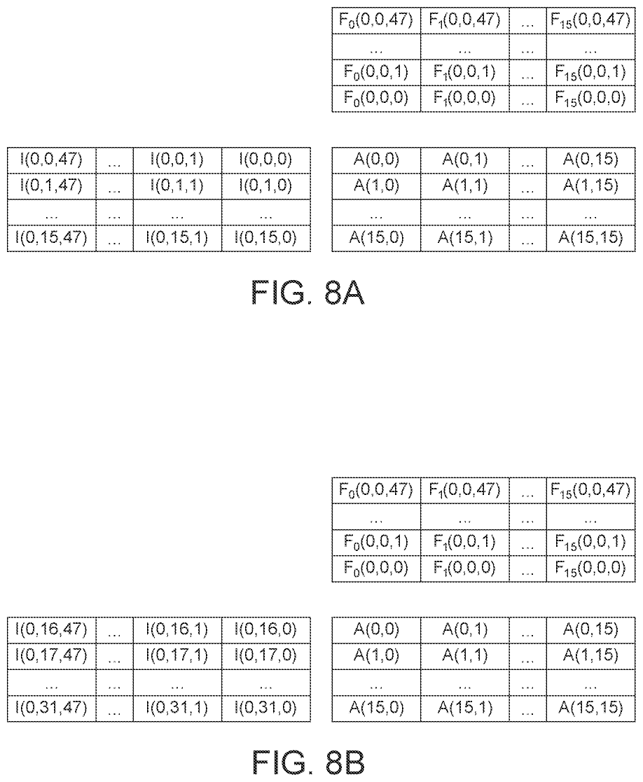

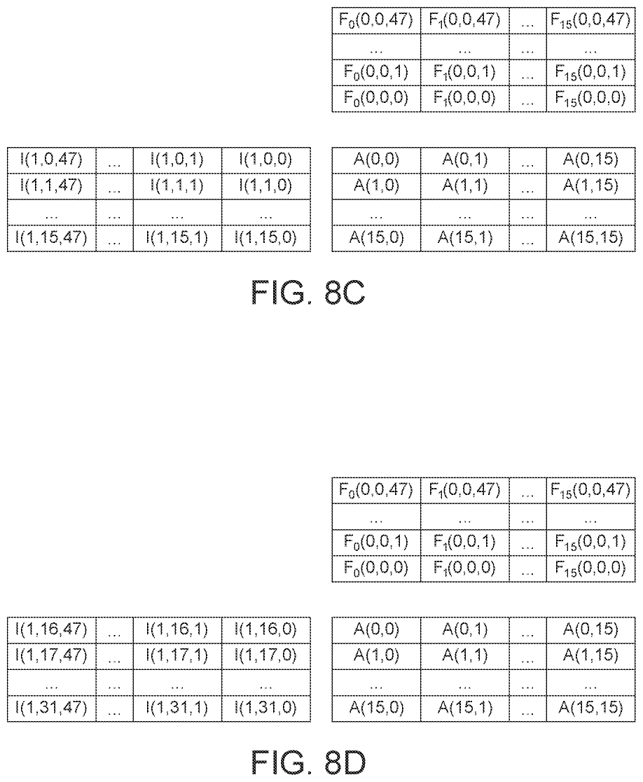

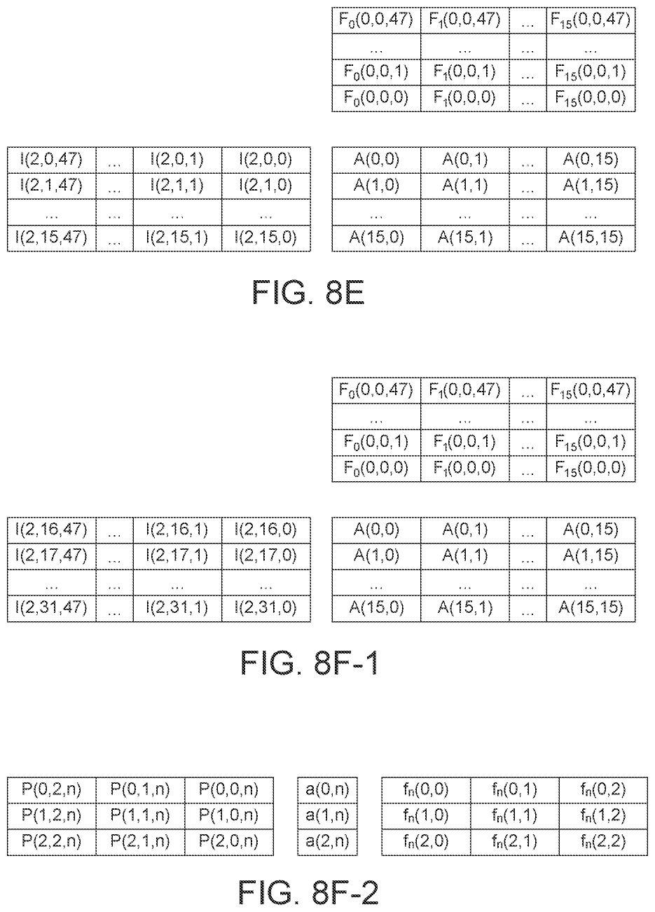

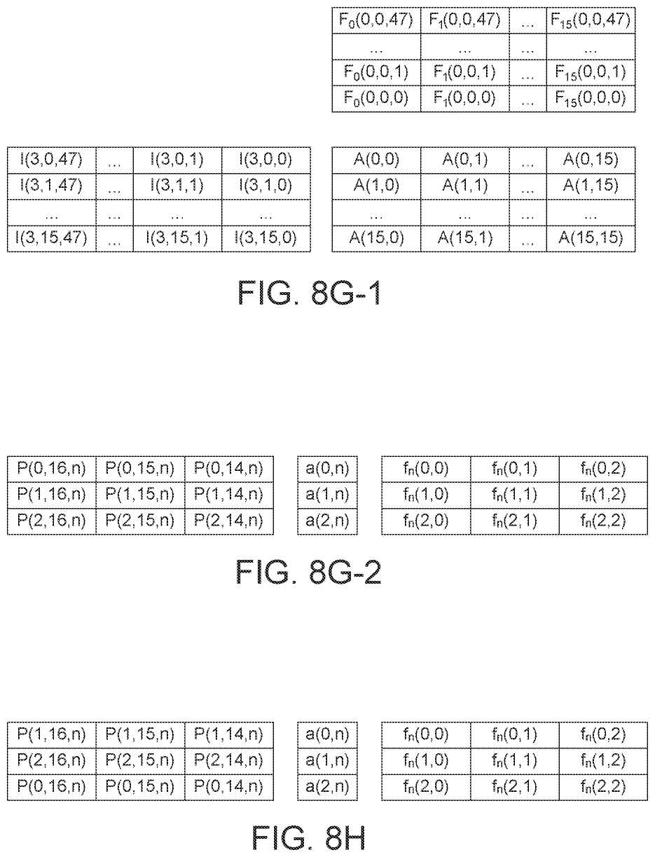

FIG. 8A to FIG. 8I show operations of the AI algorithm operation accelerator 120 according to one embodiment of the application. FIG. 8A shows the first operation in the first round. The first operations in the third to the sixth rounds are the same or similar to the first operation in the first round and the second round. In the following, the input data has size of 4*32*48, the first layer filter size is 1*1, the number of the output channels is 16, the second layer filter size is 3*3, the section width of the input data in each read is 32(WS), the batch data width of the operation in each round of the first operator is 16(WB).

A(0,n)=I(0,0,0)*Fₙ(0,0,0)+I(0,0,1)*Fₙ(0,0,1)+ . . . +I(0,0,47)*Fₙ(0,0,47).

A(1,n)=I(0,1,0)*Fₙ(0,0,0)+I(0,1,1)*Fₙ(0,0,1)+ . . . +I(0,1,47)*Fₙ(0,0,47).

A(15,n)=I(0,15,0)*Fₙ(0,0,0)+I(0,15,1)*Fₙ(0,0,1)+ . . . +I(0,15,47)*Fₙ(0,0,47).

P(0,0 . . . 15,n) includes: A(0,n)˜A(15,n), wherein P(0,0 . . . 15,n) refers to the first operation result written into the fourth register region 125 in the first round.

FIG. 8B shows the first operation in the second round.

A(0,n)=I(0,16,0)*Fₙ(0,0,0)+I(0,16,1)*Fₙ(0,0,1)+ . . . +I(0,16,47)*Fₙ(0,0,47).

A(1,n)=I(0,17,0)*Fₙ(0,0,0)+I(0,17,1)*Fₙ(0,0,1)+ . . . +I(0,17,47)*Fₙ(0,0,47).

A(15,n)=I(0,31,0)*Fₙ(0,0,0)+I(0,31,1)*Fₙ(0,0,1)+ . . . +I(0,31,47)*Fₙ(0,0,47).

P(0,16 . . . 31,n) includes: A(0,n)˜A(15,n) wherein P(0,16 . . . 31,n) refers to the first operation result written into the fourth register region 125 in the second round.

FIG. 8C shows the first operation in the third round.

A(0,n)=I(1,0,0)*Fₙ(0,0,0)+I(1,0,1)*Fₙ(0,0,1)+ . . . +I(1,0,47)*Fₙ(0,0,47).

A(1,n)=I(1,1,0)*Fₙ(0,0,0)+I(1,1,1)*Fₙ(0,0,1)+ . . . +I(1,1,47)*Fₙ(0,0,47).

A(15,n)=I(1,15,0)*Fₙ(0,0,0)+I(1,15,1)*Fₙ(0,0,1)+ . . . +I(1,15,47)*Fₙ(0,0,47).

P(1,0 . . . 15,n) includes: A(0,n)˜A(15,n) wherein P(1,0 . . . 15,n) refers to the first operation result written into the fourth register region 125 in the third round.

FIG. 8D shows the first operation in the fourth round.

A(0,n)=I(1,16,0)*Fₙ(0,0,0)+I(1,16,1)*Fₙ(0,0,1)+ . . . +I(1,16,47)*Fₙ(0,0,47).

A(1,n)=I(1,17,0)*Fₙ(0,0,0)+I(1,17,1)*Fₙ(0,0,1)+ . . . +I(1,17,47)*Fₙ(0,0,47).

A(15,n)=I(1,31,0)*Fₙ(0,0,0)+I(1,31,1)*Fₙ(0,0,1)+ . . . +I(1,31,47)*Fₙ(0,0,47).

P(1,16 . . . 31,n) includes: A(0,n)˜A(15,n) wherein P(1,16 . . . 31,n) refers to the first operation result written into the fourth register region 125 in the fourth round.

FIG. 8E shows the first operation in the fifth round.

A(0,n)=I(2,0,0)*Fₙ(0,0,0)+I(2,0,1)*Fₙ(0,0,1)+ . . . +I(2,0,47)*Fₙ(0,0,47).

A(1,n)=I(2,1,0)*Fₙ(0,0,0)+I(2,1,1)*Fₙ(0,0,1)+ . . . +I(2,1,47)*Fₙ(0,0,47).

A(15,n)=I(2,15,0)*Fₙ(0,0,0)+I(2,15,1)*Fₙ(0,0,1)+ . . . +I(2,15,47)*Fₙ(0,0,47).

P(2,0 . . . 15,n) includes: A(0,n)˜A(15,n) wherein P(2,0 . . . 15,n) refers to the first operation result written into the fourth register region 125 in the fifth round.

FIG. 8F-1 shows the first operation in the sixth round and FIG. 8F-2 shows the second operation in the sixth round. FIG. 8F-1 is described as follows.

A(0,n)=I(2,16,0)*Fₙ(0,0,0)+I(2,16,1)*Fₙ(0,0,1)+ . . . +I(2,16,47)*Fₙ(0,0,47).

A(1,n)=I(2,17,0)*Fₙ(0,0,0)+I(2,17,1)*Fₙ(0,0,1)+ . . . +I(2,17,47)*Fₙ(0,0,47).

A(15,n)=I(2,31,0)*Fₙ(0,0,0)+I(2,31,1)*Fₙ(0,0,1)+ . . . +I(2,31,47)*Fₙ(0,0,47).

P(2,16 . . . 31,n) includes: A(0,n)˜A(15,n) wherein P(2,16 . . . 31,n) refers to the first operation result written into the fourth register region 125 in the sixth round.

In the sixth round, because the second layer filter size is 3*3, the first operation result stored in the fourth register region 125 reaches the predetermined data amount, and thus the second operation is allowed to begin. In other words, in one embodiment of the application, when the data amount of the first operation is enough, the second operation is allowed to begin. However, on the contrary, in the prior art, after all the first operations are completed and written into the memory unit, the second operation is allowed to begin after the first operation results are read from the memory unit. By so, the time cost and power consumption during memory read and memory write are reduced in one embodiment of the application. Especially, in convolution operations, large amounts of operations are needed. Thus, one embodiment of the application effectively improves operation efficiency and reduces power consumption.

FIG. 8F-2 is described as follows.

a(0,n)=P(0,0,n)*fₙ(0,0)+P(0,1,n)*fₙ(0,0)+P(0,2,n)*fₙ(0,0).

a(1,n)=P(1,0,n)*fₙ(1,0)+P(1,1,n)*fₙ(1,1)+P(1,2,n)*fₙ(1,2).

a(2,n)=P(2,0,n)*fₙ(2,0)+P(2,1,n)*fₙ(2,1)+P(2,2,n)*fₙ(2,2).

O(0,0,n)=a(0,n)+a(1,n)+a(2,n). O(0,0,n) indicates the (intermediate or final) output result written into the output data storage region 113.

Similarly,

a(0,n)=P(0,1,n)*fₙ(0,0)+P(0,2,n)*fₙ(0,0)+P(0,3,n)*fₙ(0,0).

a(1,n)=P(1,1,n)*fₙ(1,0)+P(1,2,n)*fₙ(1,1)+P(1,3,n)*fₙ(1,2).

a(2,n)=P(2,1,n)*fₙ(2,0)+P(2,2,n)*fₙ(2,1)+P(2,3,n)*fₙ(2,2).

O(0,1,n)=a(0,n)+a(1,n)+a(2,n). O(0,1,n) indicates the (intermediate or final) output result written into the output data storage region 113.

Similarly,

a(0,n)=P(0,13,n)*fₙ(0,0)+P(0,14,n)*fₙ(0,0)+P(0,15,n)*fₙ(0,0).

a(1,n)=P(1,13,n)*fₙ(1,0)+P(1,14,n)*fₙ(1,1)+P(1,15,n)*fₙ(1,2).

a(2,n)=P(2,13,n)*fₙ(2,0)+P(2,14,n)*fₙ(2,1)+P(2,15,n)*fₙ(2,2).

O(0,13,n)=a(0,n)+a(1,n)+a(2,n). O(0,13,n) indicates the (intermediate or final) output result written into the output data storage region 113.

FIG. 8G-1 shows the first operation in the seventh round and FIG. 8G-2 shows the second operation in the seventh round. When the first operation in the seventh round of FIG. 8G-1 is ongoing, the second operation in the seventh round is performed concurrently. When the second operation in FIG. 8G-2 is triggered, the second operation is performed independently; and concurrently, the first operation is ongoing in continuously storing data into the fourth register region 125 to be readout for the second operation.

A(0,n)=I(3,0,0)*Fₙ(0,0,0)+I(3,0,1)*Fₙ(0,0,1)+ . . . +I(3,0,47)*Fₙ(0,0,47).

A(1,n)=I(3,1,0)*Fₙ(0,0,0)+I(3,1,1)*Fₙ(0,0,1)+ . . . +I(3,1,47)*Fₙ(0,0,47).

A(15,n)=I(3,15,0)*Fₙ(0,0,0)+I(3,15,1)*Fₙ(0,0,1)+ . . . +I(3,15,47)*Fₙ(0,0,47).

P(0,0 . . . 15,n) includes: A(0,n)˜A(15,n) wherein P(0,0 . . . 15,n) refers to the first operation result written into the fourth register region 125 in the seventh round.

FIG. 8G-2 is described as follows.

a(0,n)=P(0,14,n)*fₙ(0,0)+P(0,15,n)*fₙ(0,0)+P(0,16,n)*fₙ(0,0).

a(1,n)=P(1,14,n)*fₙ(1,0)+P(1,15,n)*fₙ(1,1)+P(1,16,n)*fₙ(1,2).

a(2,n)=P(2,14,n)*fₙ(2,0)+P(2,15,n)*fₙ(2,1)+P(2,16,n)*fₙ(2,2).

O(0,14,n)=a(0,n)+a(1,n)+a(2,n). O(0,14,n) indicates the (intermediate or final) output result written into the output data storage region 113.

Similarly,

a(0,n)=P(0,15,n)*fₙ(0,0)+P(0,16,n)*fₙ(0,0)+P(0,17,n)*fₙ(0,0).

a(1,n)=P(1,15,n)*fₙ(1,0)+P(1,16,n)*fₙ(1,1)+P(1,17,n)*fₙ(1,2).

a(2,n)=P(2,15,n)*fₙ(2,0)+P(2,16,n)*fₙ(2,1)+P(2,17,n)*fₙ(2,2).

O(0,15,n)=a(0,n)+a(1,n)+a(2,n). O(0,15,n) indicates the (intermediate or final) output result written into the output data storage region 113.

Similarly,

a(0,n)=P(0,29,n)*fₙ(0,0)+P(0,30,n)*fₙ(0,0)+P(0,31,n)*fₙ(0,0).

a(1,n)=P(1,29,n)*fₙ(1,0)+P(1,30,n)*fₙ(1,1)+P(1,31,n)*fₙ (1,2).

a(2,n)=P(2,29,n)*fₙ (2,0)+P(2,30,n)*fₙ(2,1)+P(2,31,n)*fₙ(2,2).

O(0,29,n)=a(0,n)+a(1,n)+a(2,n). O(0,29,n) indicates the (intermediate or final) output result written into the output data storage region 113.

FIG. 8H shows the continuous second operations.

a(0,n)=P(0,14,n)*fₙ(0,0)+P(0,15,n)*fₙ(0,0)+P(0,16,n)*fₙ(0,0).

a(1,n)=P(1,14,n)*fₙ(1,0)+P(1,15,n)*fₙ(1,1)+P(1,16,n)*fₙ(1,2).

a(2,n)=P(2,14,n)*fₙ(2,0)+P(2,15,n)*fₙ(2,1)+P(2,16,n)*fₙ(2,2).

O(1,14,n)=a(0,n)+a(1,n)+a(2,n). O(1,14,n) indicates the (intermediate or final) output result written into the output data storage region 113.

Similarly,

a(0,n)=P(0,15,n)*fₙ(0,0)+P(0,16,n)*fₙ(0,0)+P(0,17,n)*fₙ(0,0).

a(1,n)=P(1,15,n)*fₙ(1,0)+P(1,16,n)*fₙ(1,1)+P(1,17,n)*fₙ(1,2).

a(2,n)=P(2,15,n)*fₙ(2,0)+P(2,16,n)*fₙ(2,1)+P(2,17,n)*fₙ(2,2).

O(1,15,n)=a(0,n)+a(1,n)+a(2,n). O(1,15,n) indicates the (intermediate or final) output result written into the output data storage region 113.

Similarly,

a(0,n)=P(0,29,n)*fₙ(0,0)+P(0,30,n)*fₙ(0,0)+P(0,31,n)*fₙ(0,0).

a(1,n)=P(1,29,n)*fₙ(1,0)+P(1,30,n)*fₙ(1,1)+P(1,31,n)*fₙ(1,2).

a(2,n)=P(2,29,n)*fₙ(2,0)+P(2,30,n)*fₙ(2,1)+P(2,31,n)*fₙ(2,2).

O(1,29,n)=a(0,n)+a(1,n)+a(2,n). O(1,29,n) indicates the (intermediate or final) output result written into the output data storage region 113.

Although the above example describes the first round to the seventh round, one skilled in the art would understand how to perform operations in the subsequent rounds and thus details are omitted here.

In the above example, when the second layer filter size is 3*3, if wb=(½)*ws, after the first operation in the fifth round is completed, the second operation is triggered. In another example, when the second layer filter size is 5*5, if wb=(½)*ws, after the first operation in the ninth round is completed, the second operation is triggered. Further, when the second layer filter size is 3*3, if wb=(¼)*ws, after the first operation in the ninth round is completed, the second operation is triggered. Still further, in another example, when the second layer filter size is 3*3, if wb=1*ws, after the first operation in the third round is completed, the second operation is triggered.

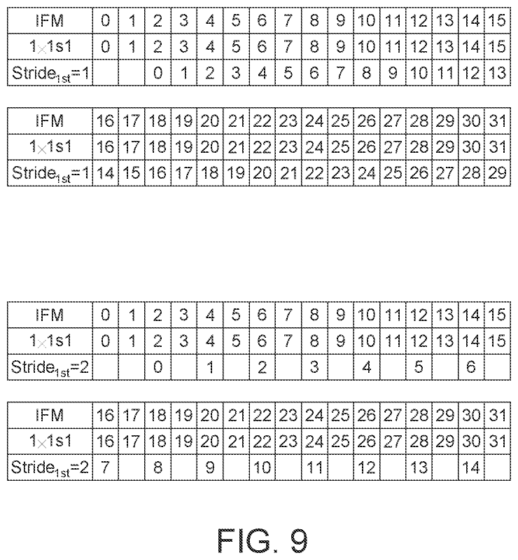

FIG. 9 shows the output data when the movement parameter Stride₁ₛₜ of the first layer convolution operation is 1 and 2, respectively, in one embodiment of the application. “IFM” refers to the input feature map. As shown in FIG. 9, when the filter size is 3*3 and the movement parameter Stride₁ₛₜ is 1 (in order to read the next data, the reading address moves forward one bit), after the second operation, 30 output data O(0, 1, n)˜O(0, 29, n) are generated from the input data having section width of 32(WS).

One embodiment of the application provides a non-transitory computer readable media storing a program code readable and executable by a computer. When the program code is executed, the computer performs steps of: A. reading an input data and a descriptor from a memory unit, wherein the descriptor includes a weight data; B. performing a first part of the input data and a first part of the weight data by a first operator for generating a first operation result; C. registering the first operation result; D. when the first operation result reaches a predetermined data amount, triggering a second operator to perform the first operation result and a second part of the weight data by the second operator for generating a second operation result; and E. writing the second operation result into the memory unit.

From the above description, in one embodiment of the application, after several rounds, the first operation and the second operation are allowed to perform concurrently. Thus, one embodiment of the application has advantages of improving overall operation efficiency.

One embodiment of the application is suitable for high efficient convolution algorithm structure to improve low operator utility rate of the prior convolution operation. As described above, in one embodiment of the application, staged operation of high efficient convolution algorithm are integrated into almost parallel processing, and thus the operation efficiency is improved.

Further, the AI algorithm operation accelerator in one embodiment of the application has advantages of not only parallel processing and staged processing, but also reducing read-write operations to the memory unit 110. Thus, one embodiment of the application has advantages of reducing power consumption and improving processing efficiency.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An AI algorithm operation accelerator adapted to perform operations on an input data in a memory unit, the memory unit including a first data storage region for storing the input data, a second data storage region for storing a descriptor which includes a weight data, and a third data storage region for storing an output data, the AI algorithm operation accelerator including:
a first register region for registering a part of the input data, wherein the first register region is configured a predetermined data length;
a second register region for registering a first part of the descriptor;
a third register region for registering a first part of the weight data;
a first operator for operating the first part of the input data and the first part of the weight data to generate a first operation result;
a fourth register region for registering the first operation result;
a fifth register region for registering a second part of the weight data; and
a second operator for operating the first operation result and the second part of the weight data to generate a second operation result,
wherein when a predetermined data amount is stored in the fourth register region, the second operator is triggered to operate the first operation result and the second part of the weight data.

2. The AI algorithm operation accelerator according to claim 1, wherein when the second operator is triggered to be in operation, the first operator continues in operating the input data.

3. The AI algorithm operation accelerator according to claim 1, wherein the predetermined data amount is configured based on a batch width and a filter parameter.

4. The AI algorithm operation accelerator according to claim 1, further including an activation unit for performing activation operations on the first operation result.

5. The AI algorithm operation accelerator according to claim 1, further including a pooling unit for performing pooling operations on the first operation result output from the fourth register region.

6. The AI algorithm operation accelerator according to claim 1, wherein
the first operator further includes a first operation element array having a plurality of first operation elements, and
each of the first operation elements is configured to: receive the input data and the first part of the weight data corresponding to multi-dimensional positions; and process the input data and the first part of the weight data to generate a plurality of operation results as the first operation result.

7. The AI algorithm operation accelerator according to claim 6, wherein
the second operator further includes a second operation element array having a plurality of second operation elements; and
each of the second operation elements is configured to: receive the first operation result and the second part of the weight data; and process the first operation result and the second part of the weight data to generate a plurality of operation results as the second operation result.

8. The AI algorithm operation accelerator according to claim 1, wherein the first operator has a first maximum operation capacity, the second operator has a second maximum operation capacity smaller than the first maximum operation capacity.

9. The AI algorithm operation accelerator according to claim 1, wherein a capacity of the fourth register region is configured at least triple times of the predetermined data length of the first register region.

10. The AI algorithm operation accelerator according to claim 7, wherein a number of the first operation elements is larger than a number of the second operation elements.

11. An AI algorithm operation accelerating method including steps of:
A. reading an input data and a descriptor from a memory unit, wherein the descriptor includes a weight data;
B. performing a first part of the input data and a first part of the weight data by a first operator for generating a first operation result;
C. registering the first operation result;
D. when the first operation result reaches a predetermined data amount, triggering a second operator to perform the first operation result and a second part of the weight data by the second operator for generating a second operation result; and
E. writing the second operation result into the memory unit.

12. The AI algorithm operation accelerating method according to claim 11, wherein in the step D, when the second operator performs the second operation, the first operator and the second operator are in parallel processing state.

13. The AI algorithm operation accelerating method according to claim 11, wherein the step A further includes steps of:
A01. reading the first part of the input data from the memory unit into a first register region;
A03. reading a first part of the descriptor from the memory unit into a second register region; and
A05. reading the first part of the weight data from the memory unit into a third register region.

14. The AI algorithm operation accelerating method according to claim 13, wherein the step C further includes storing the first operation result of the first operator into a fourth register region.

15. The AI algorithm operation accelerating method according to claim 14, wherein the step A further includes steps of:
A07. reading a second part of the weight data from the memory unit into a fifth register region.

16. The AI algorithm operation accelerating method according to claim 15, wherein after the step C, the method further includes steps of:
F. determining whether all the input data in the first register memory are read out and operated, when the step F is no, loading a next batch of the input data from the first register region, and when the step F is yes, the method proceeds to step G;
G. determining whether all data in the fourth register region is processed, when the step G is no, a data address parameter is updated, and when the step G is yes, the method proceeds to step H; and
H. determining whether any input data in the first register region is not read out yet, when the step H is no, the method ends,
wherein the predetermined data amount is configured based on a batch width and a filter parameter.

17. The AI algorithm operation accelerating method according to claim 11, wherein after the step E, the method further includes a step of:
I. determining whether all data in the fourth register region are operated by the second operation, when the step I is no, data in the fourth register region is read out for performing the second operation, and when the step I is yes, a data address is updated and the method ends.

18. The AI algorithm operation accelerating method according to claim 17, wherein after the step I, the method further includes a step of: performing activation operations on the first operation result.

19. The AI algorithm operation accelerating method according to claim 17, wherein after the step I, the method further includes a step of: performing pooling operations on the first operation result.

20. The AI algorithm operation accelerating method according to claim 13, wherein the first register region is configured a predetermined data length, and a capacity of the fourth register region is configured at least triple times of the predetermined data length.

21. A computing system including:
a memory unit including a first data storage region for storing an input data, a second data storage region for storing a descriptor which includes a weight data, and a third data storage region for storing an output data;
a memory read-write controller coupled to the memory unit, for controlling read and write of the memory unit; and
an AI algorithm operation accelerator coupled to the memory read-write controller, the AI algorithm operation accelerator including:
a first register region for registering a part of the input data, wherein the first register region is configured a predetermined data length;
a second register region for registering a first part of the descriptor;
a third register region for registering a first part of the weight data;
a first operator for operating the first part of the input data and the first part of the weight data to generate a first operation result;
a fourth register region for registering the first operation result;
a fifth register region for registering a second part of the weight data; and
a second operator for operating the first operation result and the second part of the weight data to generate a second operation result,
wherein when a predetermined data amount is stored in the fourth register region, the second operator is triggered to operate the first operation result and the second part of the weight data.

22. The computing system according to claim 21, wherein when the second operator is triggered to be in operation, the first operator continues in operating the input data.

23. A non-transitory computer readable media storing a program code readable and executable by a computer, when the program code is executed by the computer, the computer performing steps of:
A. reading an input data and a descriptor from a memory unit, wherein the descriptor includes a weight data;
B. performing a first part of the input data and a first part of the weight data by a first operator for generating a first operation result;
C. registering the first operation result;
D. when the first operation result reaches a predetermined data amount, triggering a second operator to perform the first operation result and a second part of the weight data by the second operator for generating a second operation result; and
E. writing the second operation result into the memory unit.
